(19) United States
(12) Patent Application Publication
(10) Pub. No.: US 2006/0254226 A1
(43) Pub. Date: Nov. 16, 2006

(54) Multi cyclone dust-collecting apparatus

(75) Inventor: Kyong-hui Jeon, Chungcheongnam-do (KR)

Correspondence Address: Paul D. Greeley;Ohlandt, Greeley, Ruggiero & Perle, L.L.P., One Landmark Square, 10th Floor, Stamford, CT, 06901-2682, US

(73) Assignee: SAMSUNG GWANGJU ELECTRONICS CO., LTD.

(21) Appl. No.: 11/408,760

(22) Filed: Apr. 21, 2006

(30) Foreign Application Priority Data
May 16, 2005 (KR) 10-2005-0040756
Jul. 26, 2005 (KR) 10-2005-067917

(51) Int. Cl. B01D 45/12

(52) U.S. Cl. 55/345

(57) ABSTRACT

A multi cyclone dust-collecting apparatus including a dust-collecting housing; a first cyclone; a plurality of secondary cyclones; and a cover unit is provided. The dust-collecting housing has a suction pipe, which draws in ambient air. The first cyclone is disposed in the dust-collecting housing and has a first inlet port formed on a lower portion thereof to fluidly communicate with the suction pipe. The first inlet port and an air outlet port of the first cyclone have the same axis. The plurality of secondary cyclones are arranged outside the first cyclone at a predetermined interval and disposed in the dust-collecting housing. The cover unit guides the air discharged from the first cyclone to the respective secondary cyclones, filters again the air separated out from the dirt particles in the secondary cyclones, and discharges cleaned air outwardly.

### CROSS-REFERENCE TO RELATED APPLICATIONS

This application claims benefit under 35 U.S.C. §119 from Korean Patent Application Nos. 2005-40756, filed May 16, 2005; and 2005-67917, filed Jul. 26, 2005, the entire contents of both of which are incorporated herein by reference.

### BACKGROUND OF THE INVENTION

1. Field of the Invention

The present invention relates to a dust-collecting apparatus employed in a vacuum cleaner, and more particularly, to a multi cyclone dust-collecting apparatus for centrifugally separating and removing dirt from air drawn in a vacuum cleaner by performing several processes.

2. Description of the Related Art

In general, a vacuum cleaner comprises a suction brush to draw dirt-entrained air from a cleaning surface, a dust-collecting apparatus to separate out the dirt particles from the air drawn in through the suction brush, and a suction motor serving as a driving source to generate a suction force. The conventional dust-collecting apparatus mainly uses a dust filter, which requires frequent replacement and causes unpleasantness to a user in the replacement. Therefore, a cyclone dust-collecting apparatus which can be semi-permanently used without requiring a dust filter, is coming into increasing use in recent years. The cyclone dust-collecting apparatus centrifugally separates out dirt particles from drawn-in air and collects the dirt particles.

However, one problem with the cyclone dust-collecting apparatus is its inability to completely separate out fine dirt particles. To address the problem, a cyclone dust-collecting apparatus capable of separating the fine dirt particles through two processes has been suggested in order to improve a dust-collection efficiency. Korean Patent Application Nos. 2003-62520 and 2003-63211, filed by the same assignee, disclose such a cyclone dust-collecting apparatus.

FIGS. 1 and 2 show the cyclone dust-collecting apparatus as described above. FIG. 1 is an exploded perspective view of the cyclone dust-collecting apparatus, and FIG. 2 is a cross section view illustrating the cyclone dust-collecting apparatus in an assembled state. The cyclone dust-collecting apparatus 10 comprises a cyclone unit 11 having a first cyclone 20 and a plurality of secondary cyclones 30, both of which are disposed in a housing 12, a cover unit 40 connected with the top of the cyclone unit 11 and having an inlet/outlet cover 41 and a cyclone cover 42, and a dirt receptacle 50 connected with the bottom of the cyclone unit 11. The plurality of secondary cyclones 30 are arranged outside the first cyclone 20.

The housing 12 has a lower end open and an upper end closed except for an air outlet port 23 and second air inlet ports 32 of the secondary cyclones 30. A suction pipe 13 is disposed at an upper side portion of the housing 12 to draw ambient air into the first cyclone 11. The suction pipe 13 penetrates through the housing 12 and reaches a chamber outer wall 21 of the first cyclone 20. A first air inlet port 22 is formed in the chamber outer wall 21 to fluidly communicate with the suction pipe 13.

The operation of the cyclone dust-collecting apparatus 10 having the above-described structure will now be described. Air is drawn in the first cyclone 20 through the suction pipe 13 and the first air inlet port 22, thereby forming a whirling current. Relatively large dirt particles included in the air are centrifugally separated out and collected in the dirt receptacle 50. Cleaned air passes through a grill member 25, escapes through the air outlet port 23, is guided by the inlet/outlet cover 41, and then flows into the secondary cyclones 30 through the second air inlet ports 32. The air in the secondary cyclones 30 forms a whirling current in the same way as in the first cyclone 20 such that fine dirt particles are centrifugally separated out and collected in the dirt receptacle 50. Cleaned air rises and is discharged out of the cyclone dust-collecting apparatus 10 through a discharge pipe 43 of the cyclone cover 42. Since the cyclone dust-collecting apparatus 10 having the above-described structure has the plurality of secondary cyclones 30 arranged along an outer circumference of the first cyclone 20, a dust-collection efficiency is greatly improved.

As described above, however, the ambient air must flow into the first cyclone 20 from the upper side portion of the chamber outer wall 21 to form the whirling current. Therefore, positions of the first air outlet port 22 and the suction pipe 13 fluidly communicating with the first air outlet port 22 are limited. That is, a predetermined area between the housing 12 and the chamber outer wall 21, through which the suction pipe 13 penetrates, does not provide a space to arrange the secondary cyclones 30. To this end, the number of secondary cyclones 30, which effects the dust-collection efficiency, decreases, and the secondary cyclones 30 and the inlet/outlet cover 42 of the cover unit 40 are asymmetrical. Therefore, an optimal dust-collection efficiency cannot be achieved and also there is a limitation to the designing of the cyclone dust-collecting apparatus.

Also, since the multi cyclone dust-collecting apparatus as described above cannot theoretically achieve the operation of completely separating out very fine dirt particles, a device having the capability of removing the very fine dirt particles completely is demanded.

### SUMMARY OF THE INVENTION

The present invention has been developed in order to solve the above problems in the related art. One aspect of the present invention is to provide a multi cyclone dust-collecting apparatus to increase the number of secondary cyclones in a limited space to improve a dust-collection efficiency. Another aspect of the present invention is to provide a multi cyclone dust-collecting apparatus having no limitation in arranging secondary cyclones and also changing the arrangement of the secondary cyclones according to the configurations of the vacuum cleaner and the cyclone dust-collecting apparatus. A third aspect of the present invention is to provide a multi cyclone dust-collecting apparatus having the capability of separating out very fine dirt particles, which are not still separated out by the secondary cyclones.

The above aspects are achieved by providing a multi cyclone dust-collecting apparatus, including: a dust-collecting housing that has a suction pipe formed on a bottom thereof and protruding to a predetermined length, an ambient air being drawn in through the suction pipe, the dust-collecting housing for collecting dirt particles separated out from the drawn-in air; a first cyclone that is disposed in the dust-collecting housing and has a first inlet port formed on a lower portion thereof to fluidly communicate with the suction pipe, the first cyclone for guiding the air drawn in through the first inlet port and then centrifugally separating out the dirt particles; a plurality of secondary cyclones that are arranged outside the first cyclone at a predetermined interval and disposed in the dust-collecting housing, for centrifugally separating out fine dirt particles from the air discharged from the first cyclone; and a cover unit that is disposed above the dust-collecting housing, for guiding the air discharged from the first cyclone to the respective secondary cyclones, filtering again the air separated out from the dirt particles in the secondary cyclones, and discharging cleaned air outwardly.

Preferably, but not necessarily, the first cyclone includes: a first chamber outer wall to form a first cyclone chamber in which dirt particles are centrifugally separated from the drawn-in air; a connection pipe disposed in the first chamber outer wall and having the first inlet port formed at a lower end thereof, the connection pipe formed along a height direction of the first chamber outer wall to move the air drawn in through the first inlet port upwardly in a vertical direction; an air guide member continuously formed to have a predetermined length and having a height being gradually decreased along an inner surface of the first chamber outer wall, the air guide member for guiding the air discharged through the connection pipe such that a whirling current is generated in the first cyclone chamber; and an air outlet port to discharge the air separated out from the dirt particles in the first cyclone chamber outwardly.

Preferably, but not necessarily, the first inlet port and the air outlet port have a co-axis.

Preferably, but not necessarily, a diameter of the first inlet port is smaller than that of the air outlet port.

Preferably, but not necessarily, the first chamber outer wall of the first cyclone, the connection pipe, and the air guide member are integrally formed with one another.

Preferably, but not necessarily, the multi cyclone dust-collecting apparatus further includes a separation guide member disposed above the connection pipe, for guiding the air discharged through the connection pipe toward the air guide member not to mix with an air discharged through the air outlet port.

Preferably, but not necessarily, the first cyclone further includes a cyclone housing that extends from an outer circumference of the first chamber outer wall in a circumferential direction and has insertion holes to insert the plurality of secondary cyclones therethrough.

Preferably, but not necessarily, the secondary cyclones each comprises: a second chamber outer wall forming a second cyclone chamber to separate out fine dirt particles from the air discharged from the first cyclone; and second inlet ports for allowing the air discharged from the first cyclone to flow into the second cyclone chambers.

Preferably, but not necessarily, the cover unit includes an inlet/outlet cover that has air guide channels to guide the air discharged from the air outlet port of the first cyclone to the respective second inlet ports of the secondary cyclones, and air discharge guide channels, a part of which being inserted to the second cyclone chambers to discharge the air in the second cyclone chambers outwardly; a cyclone cover for covering the inlet/outlet cover, and putting together the air discharged from the plurality of air discharge guide channels and discharging the air outwardly; and a filtering member disposed in an air moving passage between the inlet/outlet cover and the cyclone cover to filter the air discharged through the cyclone cover.

Preferably, but not necessarily, the cyclone cover includes a cylindrical cyclone cover body having a predetermined height, at least one cover inlet through which the air discharged through the air discharge guide channels of the inlet/outlet cover is drawn in, and a cover outlet to discharge the drawn-in air outwardly, and the filter member is inserted in the cyclone cover body and disposed in an air moving passage between the cover inlet and the cover outlet.

Preferably, but not necessarily, the cyclone cover body has an upper end open and the cyclone cover further comprises a cover plate detachably connected with an upper end of the cyclone cover body.

According to an embodiment of the present invention, the cover inlet is formed in a center of a bottom of the cyclone cover body and the cover outlet is formed in a sidewall of the cyclone cover body, and the air flowing in through the cover inlet ascends, collides against the cover plate, descends, passes through the filter member, and then is discharged through the cover outlet.

According to another embodiment of the present invention, the cyclone cover comprises a cyclone cover body, a plurality of cover inlets arranged around a circumference of the cyclone cover body to correspond to the air discharge guide channels of the inlet/outlet cover, and a cover outlet to discharge the drawn-in air outwardly, and the filter member does not cover the cover inlets to expose the air discharge guide channels to the outside through the cover inlets.

Preferably, but not necessarily, the cover outlet is disposed at one side of the cover plate, and the air flowing in through the cover inlets ascends, collides against the cover plate, is diffused, descends, passes through the filter member, and then is discharged through the cover outlet.

Preferably, but not necessarily, the filter member is made of a porous material.

### BRIEF DESCRIPTION OF THE DRAWINGS

These and/or other aspects of the present invention will become apparent and more readily appreciated from the following description of the embodiments, taken in conjunction with the accompanying drawings of which:

FIG. 1 is an exploded perspective view illustrating a conventional cyclone dust-collecting apparatus;

FIG. 2 is a cross section of FIG. 1;

FIG. 3 is an exploded perspective view illustrating a multi cyclone dust-collecting apparatus according to an embodiment of the present invention;

FIG. 4 is a perspective view illustrating a first cyclone of FIG. 3;

FIG. 5 is a perspective view illustrating secondary cyclones of FIG. 3;

FIG. 6 is a perspective view illustrating an inlet/outlet cover of FIG. 3;

FIG. 7 is a partially cutaway view of a cyclone cover of FIG. 3;

FIG. 8 is a perspective view of FIG. 3 in an assembled state;

FIG. 9 is an exploded perspective view illustrating a cover unit of a multi cyclone dust-collecting apparatus according to another embodiment of the present invention; and

FIG. 10 is a perspective view illustrating the cover unit of FIG. 9 in an assembled state, in which a part is cut off from a cover plate.

### DETAILED DESCRIPTION OF EXEMPLARY EMBODIMENTS

Hereinafter, a multi cyclone dust-collecting apparatus according to embodiments of the present invention will now be described with the accompanying drawings.

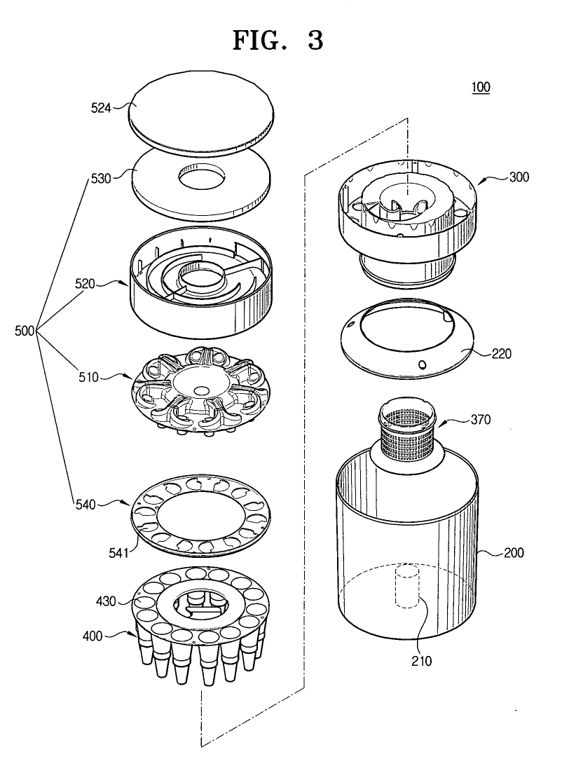

Referring to FIG. 3, a multi cyclone dust-collecting apparatus 100 comprises a dust-collecting housing 200, a first cyclone 300 disposed in the dust-collecting housing 200, a plurality of secondary cyclones 400 disposed in the dust-collecting housing 200 and arranged around an outer circumference of the first cyclone 300 at a certain interval, and a cover unit 500 disposed on the top the dust-collecting housing 200. On the first stage, the first cyclone 300 centrifugally separates out relatively large dirt particles included air drawn in from the outside, and on the second stage, the secondary cyclones 400 separate out fine dirt particles included in the air discharged from the first cyclone 300. The dust-collecting housing 200 collects dirt particles separated out from the air in the first and the second cyclones 300, 400. The cover unit 500 guides the air discharged from the first cyclone 300 to move to the second cyclones 400, and also filters the air separated out in the second cyclones 400 and discharges the filtered air to the outside.

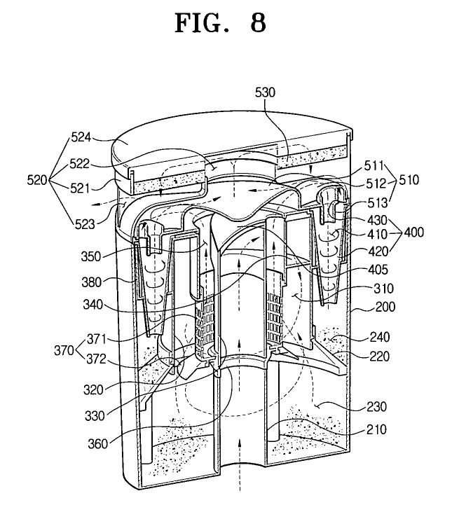

Referring to FIGS. 3 and 8, the dust-collecting housing 200 is in the shape of a cylinder such that it has an upper end open and a lower end closed except for the portion where a suction pipe 210 is disposed. The dust-collecting housing 200 forms an exterior of the multi cyclone dust-collecting apparatus 100. The suction pipe 210 vertically protrudes from the bottom of the dust-collecting housing 210 by a predetermined length, and thereby allows the ambient air to flow into the dust-collecting housing 200. A partition member 220 is disposed inside the dust-collecting housing 200 so that an end of a partition member 220 contacts with an inner surface of the dust-collecting housing 200. The partition member 220 divides the inner space of the dust-collecting housing 200 into a first dust-collector 230 to collect the dirt particles separated out from the air in the first cyclone 300 and a second dust-collector 240 to collect the dirt particles separated out from the air in the second cyclones 400. A portion of the partition member 220 is connected with a first chamber outer wall 320 of the first cyclone 300.

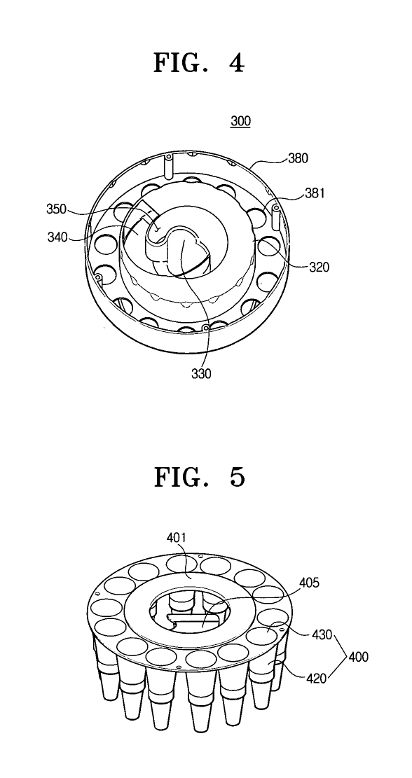

Referring to FIGS. 4 and 8, the first cyclone 300 comprises the first chamber outer wall 320 forming a first cyclone chamber 310, a connection pipe 330 disposed inside the first chamber outer wall 320, an air guide member 340 formed inside the first chamber outer wall 320, an air outlet port 350 to discharge the air from the first cyclone chamber 310 to the outside, and a grill member 370.

The first chamber outer wall 320 is substantially in the shape of a cylinder like the dust-collecting housing 210. The first chamber outer wall 320 has a lower portion open and an upper portion open through the air outlet port 350 and the connection pipe 330. The upper end of the connection pipe 330 is closed by a separation guide member 405 when the secondary cyclones 400 and the first cyclone 300 are connected with each other. Air forms a whirling current in the first cyclone chamber 310 such that the dirt is separated out from the air.

The connection pipe 330 is disposed in the first chamber outer wall 320 and has a first inlet port 360 formed at a lower end thereof The first inlet port 360 fluidly communicates with the suction pipe 210 of the dust-collecting housing 200. The connection pipe 330 is in an upright position in a height direction of the first chamber outer wall 320 and thereby guides the air drawn in through the suction pipe 210 in a vertical direction. The connection pipe 330 has the same circular cross section as the first inlet port 360 except for the upper end thereof.

The air guide member 340 is in the shape of a spiral configuration such that its height gradually decreases along the inner surface of the first chamber outer wall 320. Accordingly, the air, which rises up to the upper portion of the first chamber outer wall 320 through the first inlet port 360 and the connection pipe 330, is guided by the air guide member 340, descends while forming a whirling current, and flows into the first cyclone chamber 310. The first chamber outer wall 320, the connection pipe 330, and the air guide member 340 may be integrally formed with one another for convenience in manufacturing process and user's manipulation.

The air outlet port 350 discharges the air separated out from the dirt in the first cyclone chamber 310. The air outlet port 350 has a smaller diameter than the first chamber outer wall 320. Also, the air outlet port 350 has a larger diameter than the first inlet port 360 formed at the lower end of the connection pipe 330. The air outlet port 350 and the first inlet port 360 co-axial to one another. The first chamber outer wall 320 is co-axial with the air outlet port 350 and the first inlet port 360.

A cyclone housing 380 is disposed around the outer circumference of the first chamber outer wall 320. The cyclone housing 380 is provided with cyclone insertion holes 381 to insert the plurality of secondary cyclones 400. When the first cyclone 300 and the secondary cyclones 400 are connected with each other in the dust-collecting housing 200, the plurality of secondary cyclones 400 are inserted into the cyclone insertion holes 381 such that the cyclone housing 380 encloses a part of the upper portion of each secondary cyclone 400.

Referring to FIGS. 3 and 8, the grill member 370 prevents the relatively large dirt particles separated out in the first cyclone chamber 310 from being discharged through the air outlet port 350. The grill member 370 comprises a grill body 371 having a plurality of perforations formed thereon and a skirt 372 connected to a lower end of the grill body 371. The grill body 371 is in the shape of a cylinder and has an upper end open. The lower end of the grill body 371 is closed and the skirt is extended from a circumference of the lower end of the grill body 371. The skirt 372 prevents the dirt particles collected in the first dust collector 230 of the dust-collecting housing 200 from back-flowing.

Referring to FIGS. 5 and 8, the secondary cyclones 400 are arranged along a circumference of a plate-shaped supporting body 401, which has an opening formed in a center thereof, at a certain interval. When the secondary cyclones 400 are inserted into the dust-collecting housing 200, the secondary cyclones 400 are arranged around an outer circumference of the first chamber outer wall 320 of the first cyclone 300.

The separation guide member 405 is disposed under the supporting body 401 and has a shape corresponding to an upper end of the connection pipe 330 of the first cyclone 300. The separation guide member 405 closes the upper portion of the connection pipe 330 so as to prevent the air discharged through the connection pipe 330 from being mixed with the air discharged through the air outlet port 350. Also, the separation guide member 405 guides the air drawn in through the connection pipe 330 toward the air guide member 340. The separation guide member 405 is in the shape of an arc having a predetermined radius curvature, and guides the air drawn in through the connection pipe 330 to move to the air guide member 340 without a pressure loss. Although the separation guide member 405 is formed under the supporting body 401 where the secondary cyclones 400 are disposed in this embodiment, this should not be considered as limiting. The separation guide member 405 may be integrally formed with the upper end of the connection pipe 330.

Each of the secondary cyclones 400 comprise a second cyclone outer wall 420 to form a second cyclone chamber 410 and a second inlet port 430. The second cyclone outer wall 420 has a frustoconical having a diameter gradually smaller toward a lower end. The second cyclone outer wall 420 has both ends open. The air including fine dirt particles which have not yet been separated out in the first cyclone 300 descends in the second cyclone chamber 410, forming a whirling current, such that the fine dirt particles included in the air are centrifugally separated out and discharged through the lower end of the second chamber outer wall 420. The second inlet port 430 is formed at the open upper end of the second chamber outer wall 420 to guide the air discharged from the first cyclone to the second cyclone chamber 410. The air centrifugally separated out from the dirt in the second cyclone chamber 410 is discharged through an air discharge guide channel 513 of the inlet/outlet cover 510.

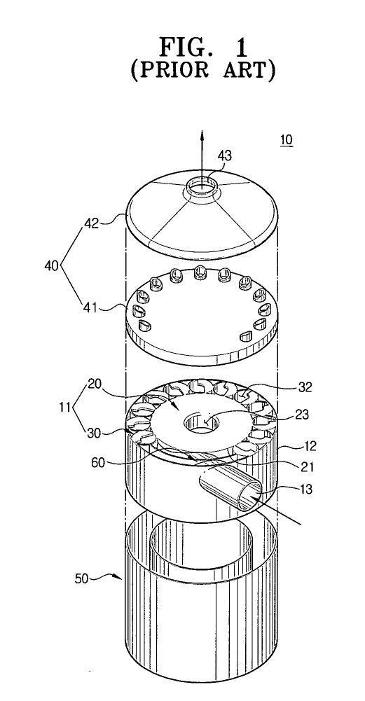

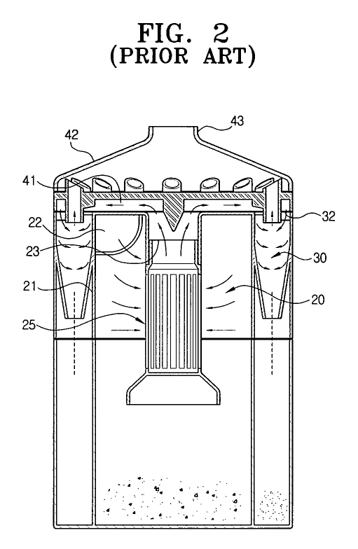

As shown in the drawings, the secondary cyclones 400 are uniformly arranged along the outer circumference of the first cyclone 300 regardless of the number of them and their arrangements, which depend on the configuration of the first cyclone 300. More specifically, in the conventional cyclone dust-collecting apparatus as shown in FIG. 1, the secondary cyclones 30 are not allowed to be formed at the certain area 60 where the suction pipe 13 is disposed. However, in the multi cyclone dust-collecting apparatus according to the present invention, the suction pipe 210 to draw in the ambient air is disposed at the bottom of the dust-collecting housing 200 and the first outlet port 360 connected to the suction pipe 210 to flow the air into the first cyclone 300 is disposed inside the first chamber outer wall 320. Accordingly, many secondary cyclones 400 can be provided without limitation to the number of them or their arrangements, which greatly improves a dust-collection efficiency of the multi cyclone dust-collecting apparatus 100.

In order to form a whirling current in the first cyclone 300, the air must flow from the upper side portion of the first chamber outer wall 320. For this, the connection pipe 330 guides the air to move up from the lower portion of the first cyclone 300 to the upper portion and the separation guide member 405 and the air guide member 340 guide the air discharged through the connection pipe 330 toward the side of the first chamber outer wall 320 to form the whirling current. Accordingly, since the dirt-entrained air can effectively use a preliminary rotation space to be able to rotate with a constant centrifugal force promptly when flowing into the first cyclone 300, a pressure loss is prevented and a suction force is constantly maintained.

Referring back to FIG. 3, the cover unit 500 comprises the inlet/outlet cover 510, a cyclone cover 520 arranged above the inlet/outlet cover 510, a filter member 530, and a sealing member 540.

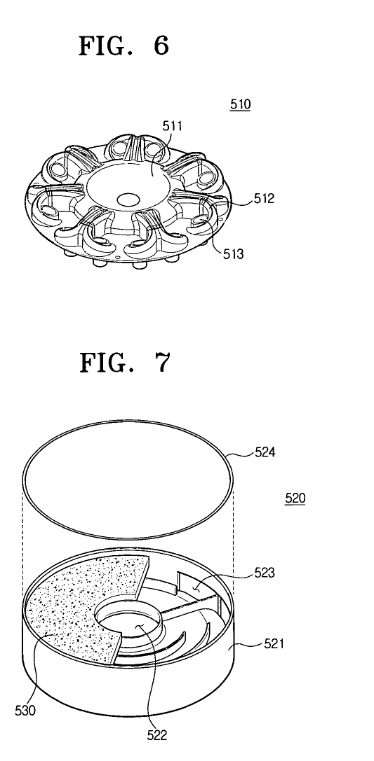

Referring to FIGS. 6 and 8, the inlet/outlet cover 510 guides the air discharged from the first cyclone 300 to the respective secondary cyclones 400. The inlet/outlet cover 510 comprises a plate-shaped inlet/outlet cover body 533 having a predetermined height, air guide channels 512, and the air discharge guide channels 513. The air guide channels 512 are arranged in a radial direction with reference to a center of the inlet/outlet cover body 511. The air guide channels 512 fluidly communicate the air outlet port 350 of the first cyclone 300 with the second inlet ports 430 of the secondary cyclones 400. The air discharge guide channels 513 are formed in a vertical direction and have a predetermined height. The air centrifugally separated out from the fine dirt particles in the second cyclone chambers 410 of the secondary cyclones 400 ascends and is discharged through the air discharge guide channels 513. When the inlet/outlet cover 510 is connected with the secondary cyclones 400, a part of each discharge guide channel 513 is inserted into each secondary cyclone 400.

Referring to FIGS. 7 and 8, the cyclone cover 520 covers the inlet/outlet cover 510, and comprises a cyclone cover body 521, a cover inlet 523, a cover outlet 523, and a cover plate 524. FIG. 7 shows a part of the filter member 530 of FIG. 3 for the sake of brevity. The cyclone cover body 521 is in the shape of a cylinder having a predetermined height, and has the cover inlet 522 formed in a bottom center thereof to put together the air discharged from the second cyclones 400 through the discharge guide channels 513 and draw the air. The cyclone cover body 521 has the cover outlet 523 formed at a side thereof to discharge the air. In this embodiment, the cover inlet 522 is formed in the bottom center of the cyclone cover body 521 and the cover outlet 523 is formed at the side of the cyclone cover body 521. However, this should not be considered as limiting. The cover plate 524 is connected with an upper end of the cyclone cover body 521. The air drawn in through the cover inlet 522 ascends, collides against the cover plate 524, is diffused, and descends. The descending air passes through the filter member 530 and is discharged to the outside through the cover outlet 523.

The inlet/outlet cover 510 and the cyclone cover 520 may be integrally formed with each other or may be formed separately.

The filter member 530 is inserted in the cyclone cover body 521 and is disposed in an air moving passage between the cover inlet 522 and the cover outlet 523. The filter member 530 is higher than the cover outlet 523 in position. The air drawn up through the cover inlet 522 passes down through the filter member 530 and is discharged out of the multi cyclone dust-collecting apparatus 100 through the cover outlet 523. Accordingly, since the very fine dirt particles which have not yet been centrifugally separated out in the secondary cyclones 400 are filtered by the filter member 530, the multi cyclone dust-collecting apparatus 100 can improve a dust-collection efficiency. In order to filter the very fine dirt particles, the filter member 530 is made of porous material such as sponge.

Although in this embodiment the filter member 530 is disposed between the cover inlet 522 of the cyclone cover 520 and the cover outlet 523, this should not be considered as limiting. In another embodiment, the filter member 530 is disposed between the inlet/outlet cover 510 and the cyclone cover 520. The filter member 530 functions to filter the very fine dirt particles included in the air discharged from the secondary cyclones 400, such that even if the filter member 530 is disposed in an air moving between the inlet/outlet cover 510 and the cyclone cover 520, it can achieve the same effect as in this embodiment.

Referring back to FIG. 3, the sealing member 540 comprises penetrating holes 541 penetratingly formed corresponding to the second inlet ports 430 of the secondary cyclones 400. The penetrating holes 541 of the sealing member 540 adjusts the respective cross sections of the second inlet ports 430 of the secondary cyclones 400 to determine fluxes of the whirling current entering the secondary cyclones 400, and sets an optimized whirling current flux such that a centrifugal separation is more smoothly performed in the secondary cyclones 400.

With reference to FIG. 8, the operation of the multi cyclone dust-collecting apparatus 100 according to an embodiment of the present invention as described above will now be described.

The dirt-entrained air rises up to the upper portion of the first cyclone 300 through the suction pipe 210 of the dust-collecting housing 200, the first inlet port 360, and the connection pipe 330. The air discharged through the connection pipe 330 is guided toward the air guide member 340 by the separation guide member 405. The air guided by the air guide member 340 moves down to the first cyclone chamber 310, forming a whirling current such that relative large dirt particles are centrifugally separated out, drop down and are collected in the first dust collector 230 of the dust-collecting housing 200. The air separated out from the large dirt particles rises up again, passing through the grill body 371 of the grill member 370, and is discharged through the air outlet port 350. At this time, dirt particles having a size larger than that of the perforation of the grill body 370 do not flow into the grill body 371 and are filtered.

The air ascending through the air outlet port 350 collides against the inlet/outlet cover body 511, is diffused, passes through the air guide channels 512, and enters the second cyclone chambers 410 through the second inlet ports 430 of the secondary cyclones 400. The air forms a whirling current due to the structure of the air guide channel 512 such that fine dirt particles are centrifugally separated. That is, the air descends forming a whirling current such that the fine dirt particles which have not yet been separated out in the first cyclone 300 are centrifugally separated out, drop down, and are collected in the second dust collector 240 of the dust-collecting housing 200.

After being separated out from the fine dirt particles, the air is discharged through each air discharge guide channel 513 and is combined. The combined air flows into the cover inlet 522 of the cyclone cover body 521. The air ascends, collides with the cover plate 524, is diffused, descends and passes through the filter member 530. The air cleaned after passing through the filter member 530 is discharged out of the multi cyclone dust-collecting apparatus 100 through the cover outlet 523. The cover plate 523 is directly or indirectly connected to a driving motor (not shown) of the vacuum cleaner for providing a driving force.

Albeit not shown, various types of vacuum cleaners such as upright type vacuum cleaners or canister type vacuum cleaner selectively employ the cyclone dust-collecting apparatus 100 as described above.

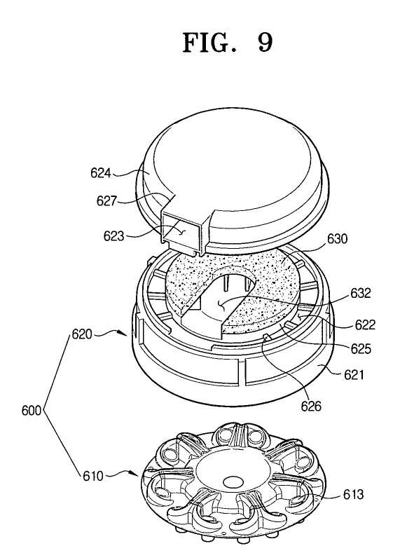

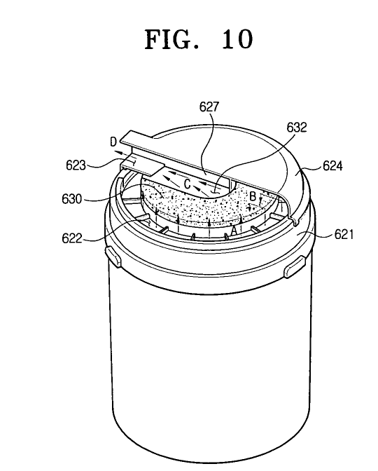

FIGS. 9 and 10 are views illustrating a cover unit 600 according to another embodiment of the present invention. More specifically, FIG. 9 is an exploded perspective view of the cover unit 600, and FIG. 10 is a perspective view showing a cyclone dust-collecting apparatus assembled with the cover unit 600, which shows a part of a cover plate to more specifically explain the operation of the cover unit 600.

Referring to FIG. 9, the cover unit 600 comprises an inlet/outlet cover 610, a cyclone cover 620, and a filter member 630. Since the inlet/outlet cover 610 has the same structure and the same function as those in the prior embodiment, a detailed description thereof will be omitted. According to another embodiment of the present invention, the cyclone cover 620 covers the inlet/outlet cover 610 and comprises a cyclone cover body 621, cover inlets 622, and a cover plate 624 having a cover outlet 623.

The cyclone cover body 621 is in a substantially cylindrical shape and has a predetermined height. The cover inlets 622 are arranged along a circumference of the cyclone cover body 621 to correspond to air discharge guide channels 613 of the inlet/outlet cover 610. Accordingly, if the cover plate 624 is separated from the cyclone cover body 621, the air discharge guide channels 613 are exposed to the outside through the cover inlets 622. The air discharged from the respective secondary cyclones 410 (see FIG. 8) through the air discharge guide channels 613 ascends in a vertical direction through the cover inlets 622.

A filter member 630 is seated on a filter supporting member 625 supported on supporting ribs 626 of the cyclone cover body 621. In the same way as the prior embodiment, the filter member 630 is disposed in an air moving passage between the cover inlets 622 of the cyclone cover 620 and the cover outlet 623 and functions to filter very fine dirt particles out from the air. The filter member 630 is designed not to cover the cover inlets 622 so as to expose the air discharge guide channels 613 to the outside through the cover inlets 622. As shown in FIG. 9, the filter member 630 has a cutoff part 632 formed therein. A guide duct 627 (see FIG. 10) formed on the cover plate 624 is inserted into the cutoff part 632.

The cover plate 624 is detachably connected with the upper end of the cyclone cover body 621 and has the guide duct 627. The guide duct 627 is in a tubular shape having the bottom open except for the cover outlet 623 formed at a lower end thereof and is inserted to the cutoff part 632 of the filter member 630. That is, when the cover plate 624 is connected with the cyclone cover body 621, the guide duct 627 is inserted to the cutoff part 632 to penetrate through the filter member 630.

With reference to FIG. 10, the operation of the cover unit 600 according to another embodiment of the present invention will now be described. For the sake of brevity, FIG. 10 illustrates the cover plate 624 from which a part is cut away.

The air discharged from the plurality of air discharge guide channels 613 moves upward in a vertical direction as indicated by arrows ‘A’ and flows in through the cover inlets 622 (see FIGS. 8 and 9). The ascending air collides against the cover plate 624, moves downward in the direction of arrow ‘B’, and passes through the filter member 630. Since the guide duct 627 is inserted to the cutoff part 632 of the filter member 630, the air does not enter the cutoff part 632 and passes through the filter member 630. The air passing through the filter member 630 is collected toward a center as indicated by arrow ‘C’, ascends through the cutoff part 632, passes through the cover outlet 623 as indicated by arrow ‘D’, and is discharged to the outside.

According to another embodiment of the present invention, a user easily cleans or repairs the filter member 630 simply by separating the cover plate 624 from the cover unit 600. In addition, the multi cyclone dust-collecting apparatus 100 has the following advantages. If the cover plate 624 is separated from the cyclone cover body 621, the air discharge guide channels 613 are exposed to the outside through the cover inlets 622. Accordingly, a user can check a clogging state of the air discharge guide channels 613, and if the discharge guide channels 613 are clogged, the user easily cleans and repairs the discharge guide channels 613 by separating only the cover plate 624 without having to disassemble the cover unit 660.

As described above, since the air inlet port to draw the air into the first cyclone 300 is formed on the bottom of the multi cyclone dust-collecting apparatus 100, the multi cyclone dust-collecting apparatus has no limitation to arrange the secondary cyclones 400. Accordingly, since many secondary cyclones 400 can be provided regardless of the number of them and their arrangements, the dust-collection efficiency is greatly improved. Due to the presences of the connection pipe 330 connected to the inlet port of the first cyclone 300, the separation guide member 405 and the air guide member 340, the air turns with a constant centrifugal force promptly when flowing into the first cyclone, and thus, a pressure loss of the air can be decreased and the suction force can be maintained.

Also, since the air discharged from the secondary cyclones 400 are once again filtered prior to being discharged from the cyclone dust-collecting apparatus 100, the very fine dirt particles, which have not yet been separated out in the secondary cyclones 400, are separated out. Accordingly, the dust-collection efficiency is improved. Also, according to another embodiment of the present invention, the discharge guide channels 613 as well as the filter member 630 can be easily cleaned or repaired by separating only the filter plate 624.

Also, since the first cyclone 300 and the secondary cyclones 400 are integrated into the dust-collecting housing 200, the multi cyclone dust-collecting apparatus 100 has a very compact structure.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A multi cyclone dust-collecting apparatus, comprising:
a dust-collecting housing that has a suction pipe formed on a bottom thereof and protruding to a predetermined length to allow an ambient air to be drawn in through the suction pipe, the dust-collecting housing for collecting dirt particles separated out from the drawn-in air;
a first cyclone that is disposed in the dust-collecting housing and has a first inlet port formed on a lower portion thereof to fluidly communicate with the suction pipe, the first cyclone for guiding the air drawn in through the first inlet port and then centrifugally separating out the dirt particles;
a plurality of secondary cyclones that are arranged outside the first cyclone at a predetermined interval and disposed in the dust-collecting housing, the plurality of secondary cyclones for centrifugally separating out fine dirt particles from the air discharged from the first cyclone; and
a cover unit that is disposed above the dust-collecting housing, the cover unit for guiding the air discharged from the first cyclone to the plurality of secondary cyclones, filtering again the air separated out from the dirt particles in the secondary cyclones, and discharging cleaned air outwardly.

2. The multi cyclone dust-collecting apparatus as claimed in claim 1, wherein the first cyclone comprises:
a first chamber outer wall to form a first cyclone chamber in which dirt particles are centrifugally separated from the drawn-in air;
a connection pipe disposed in the first chamber outer wall and having the first inlet port formed at a lower end thereof, the connection pipe formed along a height direction of the first chamber outer wall to move the air drawn in through the first inlet port upwardly in a vertical direction;
an air guide member continuously formed to have a predetermined length and having a height gradually decreasing along an inner surface of the first chamber outer wall, the air guide member for guiding the air discharged through the connection pipe such that a whirling current is generated in the first cyclone chamber; and
an air outlet port to discharge the air separated out from the dirt particles in the first cyclone chamber outwardly.

3. The multi cyclone dust-collecting apparatus as claimed in claim 1, wherein the first inlet port and the air outlet port are co-axial to one another.

4. The multi cyclone dust-collecting apparatus as claimed in claim 3, wherein the first inlet port has a diameter that is smaller than a diameter of the air outlet port.

5. The multi cyclone dust-collecting apparatus as claimed in claim 2, wherein the first chamber outer wall of the first cyclone, the connection pipe, and the air guide member are integrally formed with one another.

6. The multi cyclone dust-collecting apparatus as claimed in claim 2, further comprising a separation guide member disposed above the connection pipe, the separation guide member for guiding the air discharged through the connection pipe toward the air guide member without mixing with an air discharged through the air outlet port.

7. The multi cyclone dust-collecting apparatus as claimed in claim 2, wherein the first cyclone further comprises a cyclone housing that extends from an outer circumference of the first chamber outer wall in a circumferential direction and has insertion holes to insert the plurality of secondary cyclones therethrough.

8. The multi cyclone dust-collecting apparatus as claimed in claim 2, wherein the plurality of secondary cyclones each comprise: a second chamber outer wall forming a second cyclone chamber to separate out fine dirt particles from the air discharged from the first cyclone; and second inlet ports for allowing the air discharged from the first cyclone to flow into the second cyclone chambers, and
wherein the cover unit comprises:
an inlet/outlet cover that has air guide channels to guide the air discharged from the air outlet port of the first cyclone to the respective second inlet ports of the plurality of secondary cyclones, and air discharge guide channels, a part of which being inserted to the second cyclone chambers to discharge the air in the second cyclone chambers outwardly;
a cyclone cover for covering the inlet/outlet cover, and combining the air discharged from the plurality of air discharge guide channels and discharging the air outwardly; and
a filtering member disposed in an air moving passage between the inlet/outlet cover and the cyclone cover to filter the air discharged through the cyclone cover.

9. The multi cyclone dust-collecting apparatus as claimed in claim 8, wherein the cyclone cover comprises a cylindrical cyclone cover body having a predetermined height, at least one cover inlet through which the air discharged through the air discharge guide channels of the inlet/outlet cover is drawn in, and a cover outlet to discharge the drawn-in air outwardly, and
wherein the filter member is inserted in the cyclone cover body and disposed in an air moving passage between the cover inlet and the cover outlet.

10. The multi cyclone dust-collecting apparatus as claimed in claim 9, wherein the cyclone cover body has an upper end open and the cyclone cover further comprises a cover plate detachably connected with an upper end of the cyclone cover body.

11. The multi cyclone dust-collecting apparatus as claimed in claim 10, wherein the cover inlet is formed in a center of a bottom of the cyclone cover body and the cover outlet is formed in a sidewall of the cyclone cover body,
wherein the air flowing in through the cover inlet ascends, collides against the cover plate, descends, passes through the filter member, and then is discharged through the cover outlet.

12. The multi cyclone dust-collecting apparatus as claimed in claim 8, wherein the cyclone cover comprises a cyclone cover body, a plurality of cover inlets arranged around a circumference of the cyclone cover body to correspond to the air discharge guide channels of the inlet/outlet cover, and a cover outlet to discharge the drawn-in air outwardly, and
wherein the filter member does not cover the cover inlets to expose the air discharge guide channels to the outside through the cover inlets.

13. The multi cyclone dust-collecting apparatus as claimed in claim 12, wherein the cyclone cover body has an upper end open, and the cyclone cover further comprises a cover plate that is detachably connected with an upper end of the cyclone cover body.

14. The multi cyclone dust-collecting apparatus as claimed in claim 13, wherein the cover outlet is disposed at one side of the cover plate, and the air flowing in through the cover inlets ascends, collides against the cover plate, is diffused, descends, passes through the filter member, and then is discharged through the cover outlet.

15. The multi cyclone dust-collecting apparatus as claimed in claim 8, wherein the filter member is made of a porous material.

16. The multi cyclone dust-collecting apparatus as claimed in claim 2, wherein the dust-collecting housing is provided with a partition such that the dirt separated out from the air in the first cyclone and the secondary cyclones are separately collected, and an end of the partition is connected with a lower end of the first chamber outer wall.

17. A multi cyclone dust-collecting apparatus comprising:
a dust-collecting housing to collect dirt particles separated out from drawn-in air;
a first cyclone that is disposed in the dust-collecting housing, the first cyclone for centrifugally separating out the dirt particles from the drawn-in air;
a plurality of secondary cyclones that are arranged to enclose the first cyclone in a radial direction and centrifugally separate out fine dirt particles from the air discharged from the first cyclone; and
a suction pipe that upwardly protrudes from a lower portion of the dust-collecting housing to allow ambient air to flow from the lower portion of the dust-collecting housing toward the first cyclone.

18. The multi cyclone dust-collecting apparatus as claimed in claim 17, further comprising a filter member disposed above the dust-collecting housing to separate out dirt particles from the air discharged from the secondary cyclones.

19. The multi cyclone dust-collecting apparatus as claimed in claim 18, further comprising a cyclone cover that is disposed above the plurality of secondary cyclones, the cyclone cover for collecting the air discharged from the plurality of secondary cyclones and discharging the air, wherein the filter member is disposed in the cyclone cover.
